(19) United States
(12) Patent Application Publication
(10) Pub. No.: US 2018/0311686 A1
(43) Pub. Date: Nov. 1, 2018

(54) ROTATIONAL WAVE NOZZLE

(71) Applicant: Fuji Electric Co., Ltd., Kanagawa (JP)

(72) Inventor: Hitoshi SHIMIZU, Tokyo (JP)

(73) Assignee: Fuji Electric Co., Ltd., Kanagawa (JP)

(21) Appl. No.: 15/916,003

(22) Filed: Mar. 8, 2018

(30) Foreign Application Priority Data
Apr. 28, 2017 (JP) 2017-089175

(51) Int. Cl. B05B 3/00; B05B 3/06

(52) U.S. Cl. CPC B05B 3/003; B05B 3/06

(57) ABSTRACT

A rotational wave nozzle includes a fixed housing having a hollow cylindrical shape; a rotary cylinder inside the fixed housing such that the rotary cylinder is freely rotatable about the axial direction; a spray nozzle fixed on a front side of the rotary cylinder, emitting a compressed gas received by a rear end of the rotary cylinder outwardly, an emission direction of the spray nozzle being inclined relative to the axial direction of the rotary cylinder so that the emitted compressed gas causes the rotary cylinder and the spray nozzle fixed thereto to rotate; and a rotation suppressor fixed on a circumference side of the rotary cylinder, the rotation suppressor having a movable member that moves outwardly in a radial direction in response to a centrifugal force such that the movable member causes the rotation of the rotary cylinder due to the emitted compressed gas to be braked.

### BACKGROUND OF THE INVENTION

### Technical Field

The present invention relates to a rotational wave nozzle that intermittently sprays a fluid onto a workpiece.

### Background Art

As a device for spraying fluid onto a workpiece, an air gun is known which ejects compressed air and sprays the ejected compressed air onto a wet-washed workpiece, thus drying the workpiece by removing liquid droplets. This type of air gun is also used in the process for delivering semiconductor chips. Namely, in the process for delivering a semiconductor chip, the tray that transports and protects the semiconductor chips to be delivered is washed with warm water, and then compressed air is sprayed onto the wet tray with the air gun in order to spray off the liquid droplets, after which the tray is put into a drying furnace and dried.

In the spray drying method using the air gun, phenomena can be observed in which the liquid droplets run on the surface of the tray, go around to the back surface of the tray, etc. Therefore, drying by using an air gun cannot sufficiently remove liquid droplets remaining on the surface of the tray, and this necessitates a long drying period in the drying furnace.

As a method for reducing phenomena in which liquid droplets run on the surface of the tray, go around to the back surface of the tray, etc., there is a known technique whereby a nozzle from which compressed air is ejected is rotated, with compressed air being intermittently sprayed onto the workpiece (see Patent Document 1, for example). The rotational wave nozzle disclosed in Patent Document 1 will be described next.

FIG. 11 is a cross-sectional view of an example of a conventional rotational wave nozzle. FIG. 12 is a bottom view of the conventional rotational wave nozzle. FIG. 13 is a graph showing changes in drying quality relative to the number of rotations of the rotational wave nozzle.

The rotational wave nozzle shown in FIG. 11 and FIG. 12 has a rotor 104 in which both ends of a hollow cylindrical body 101 are sealed by discs 102 and 103. Nozzles 105 are attached to the disc 102, and a rotary shaft 106 made of a hollow pipe is coaxially attached to the disc 103. The rotary shaft 106 is supported by a fixed pipe 108 via bearings 107 so as to be freely rotatable. A cover 109 is attached to one end of the fixed pipe 108, and a sealing material 110 for preventing air leaks is attached between the rotary shaft 106 and the fixed pipe 108.

As shown in FIG. 12, two of the nozzles 105 are attached to locations that are symmetrical about the rotation center of the disc 102. As shown in FIG. 11, the nozzle 105 is attached at an incline relative to the disc 102.

When compressed air is introduced to the rotary shaft 106 in the rotational wave nozzle having the aforementioned configuration, the compressed air is guided to the rotor 104 via the rotary shaft 106 and then ejected to outside from the nozzle 105. At this time, the rotary shaft 106 is supported by the bearings 107 so as to be freely rotatable, and the compressed air is ejected from the nozzles 105 in a direction that are inclined relative to the axial direction of the rotation center. In other words, in the rotational wave nozzle shown in FIG. 12, the nozzle 105 installed above the rotation center of the rotor 104 in the drawing ejects compressed air in the leftward direction shown by the arrow 111, and the nozzle 105 installed below the rotation center of the rotor 104 in the drawing ejects compressed air in the rightward direction shown by the arrow 112. In this manner, the ejection of the compressed air produces a propulsive force, which rotates the rotor 104 in the opposite direction of the direction in which the compressed air is ejected (the clockwise direction shown by arrow 113 in FIG. 12). Thus, the rotational wave nozzle rotates about its own axis while compressed air is being ejected; thus, when a workpiece (an object to be cleaned) is placed facing the disc 102, the air ejected from the nozzle 105 is sprayed along a circle circumference on the workpiece. In other words, if viewing one point on the circle circumference on the workpiece on which the compressed air is sprayed, the compressed air would be sprayed periodically, and thus the rotational wave nozzle ejects the compressed air with rotational wave on the circle circumference on the workpiece in a wavelike (periodic, intermittent) pattern.

The rotational wave nozzle ejects compressed air with rotational waves; therefore, compared to an air gun which continuously ejects constant compressed air, the rotational wave nozzle is more capable of spraying off liquid droplets without the liquid droplets running along the surface of the workpiece, going around to the back surface of the tray, or the like, and thereby making it possible to improve drying performance.

### RELATED ART DOCUMENT

### Patent Document

Patent Document 1: Japanese Patent Application Laid-Open Publication No. 2008-36617

### SUMMARY OF THE INVENTION

However, the rotary shaft of the rotational wave nozzle is supported by the bearings so as to be freely rotatable and can easily rotate even due to low-pressure compressed air, which makes it easy for the number of rotations to increase. There is a problem in that a high number of rotations can worsen drying quality. Namely, as shown in FIG. 13, there is a relationship between the number of rotations of the rotational wave nozzle and drying quality, and when the number of rotations exceeds the optimal value, it becomes difficult to efficiently spray off the liquid droplets. In other words, until the number of rotations reaches the optimal value, the rotational wave nozzle is spraying the compressed air onto the workpiece in the wavelike (periodic, intermittent) pattern, thus allowing for the liquid droplets to be efficiently sprayed off. However, when the number of rotations exceeds the optimal value, the intervals between the compressed air being blown in the wavelike pattern become gradually shorter, and eventually the compressed air ceases to produce waves. This is equivalent to continuous ejection of the compressed air, which degrades drying quality. Furthermore, a high number of rotations of the rotational wave nozzle shortens the lifespan of the bearings and also creates more noise.

The present invention was made in view of the above issues and aims at providing a rotational wave nozzle that prevents the number of rotations from being higher than necessary.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a rotational wave nozzle, including: a fixed housing having a hollow cylindrical shape; a rotary cylinder supported by two bearings provided separately in an axial direction inside the fixed housing such that the rotary cylinder is freely rotatable about the axial direction, a rear end of the rotary cylinder being configured to receive a compressed gas; a spray nozzle fixed on a front side of the rotary cylinder, emitting the compressed gas received by the rear end of the rotary cylinder outwardly, an emission direction of the spray nozzle being inclined relative to the axial direction of the rotary cylinder so that the emitted compressed gas causes the rotary cylinder and the spray nozzle fixed thereto to rotate; and a rotation suppressor fixed on a circumference side of the rotary cylinder, the rotation suppressor having a movable member that moves outwardly in a radial direction in response to a centrifugal force that is generated by the rotation of the rotary cylinder such that the movable member causes the rotation of the rotary cylinder due to the emitted compressed gas to be braked.

In the rotational wave nozzle of the aforementioned configuration, the rotation suppressor suppresses the number of rotations when the number of rotations of the rotary cylinder becomes higher than a prescribed number; thus, the rotational wave nozzle is advantageous in preventing the number of rotations from becoming higher than necessary.

Furthermore, because the number of rotations is prevented from becoming higher than necessary, it is possible to extend the lifespan of the bearings supporting the rotary cylinder and to eliminate noise caused by high rotations, thus allowing for a quiet working environment. Moreover, when applied to the drying of wet components, it is possible for the drying to be high quality and fast.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is a cross-sectional view of a rotational wave nozzle of Embodiment 1.

FIG. 2 is a side view of the rotational wave nozzle seen from the side of the spray nozzle.

FIG. 3 is a cross-sectional view along the arrow A-A in FIG. 1 and shows the rotational wave nozzle while stopped.

FIG. 4 is a cross-sectional view along the arrow A-A in FIG. 1 and shows the rotational wave nozzle while operational.

FIG. 5 is a side view of a rotational wave nozzle of Embodiment 2 as seen from the side of the spray nozzle.

FIG. 6 is a cross-sectional view along the arrow B-B in FIG. 5 and shows the rotational wave nozzle of Embodiment 2.

FIG. 7 is a cross-sectional view along the arrow C-C in FIG. 5 and shows the rotational wave nozzle of Embodiment 2 while stopped.

FIG. 8 is a cross-sectional view along the arrow D-D in FIG. 7 and shows the rotational wave nozzle of Embodiment 2 while stopped.

FIG. 9 is a cross-sectional view along the arrow C-C in FIG. 5 and shows the rotational wave nozzle of Embodiment 2 while operational.

FIG. 10 is a cross-sectional view along the arrow E-E in FIG. 9 and shows the rotational wave nozzle of Embodiment 2 while operational.

FIG. 11 is a cross-sectional view of an example of a conventional rotational wave nozzle.

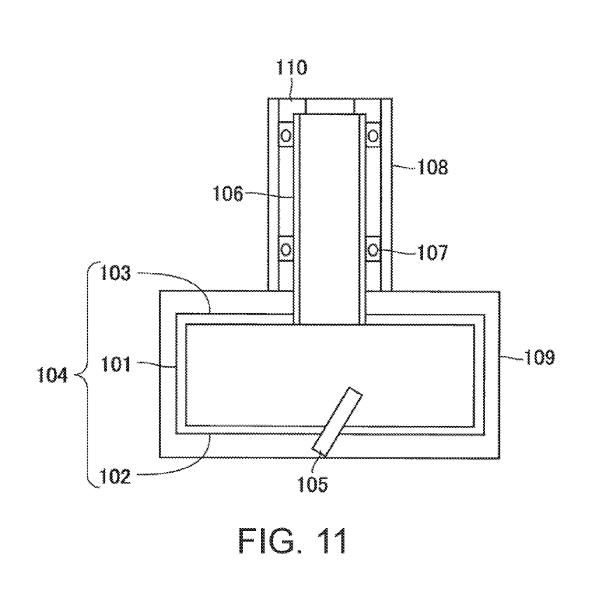

FIG. 12 is a bottom view of the conventional rotational wave nozzle.

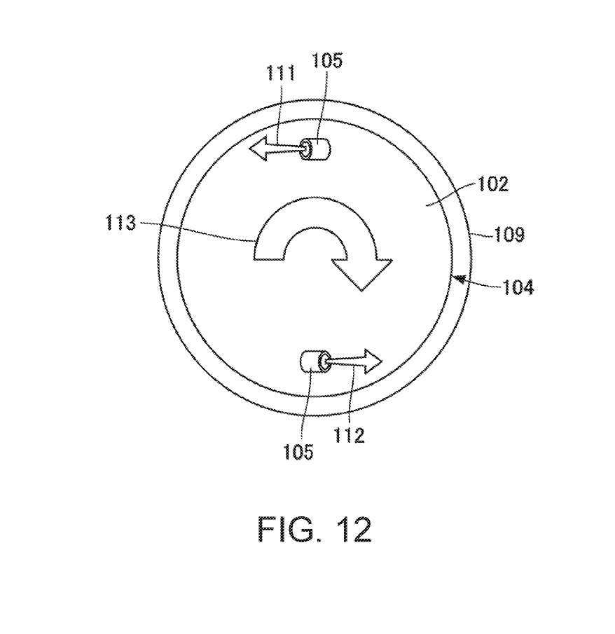

FIG. 13 is a graph showing changes in drying quality relative to the number of rotations of the rotational wave nozzle.

### DETAILED DESCRIPTION OF EMBODIMENTS

Embodiments of the present invention will be described in detail below with reference to the drawings based on an example of a rotational wave nozzle that ejects compressed air in a wavelike pattern toward an object to be cleaned. Each embodiment can be combined with parts from a plurality of embodiments without contradiction.

### Embodiment 1

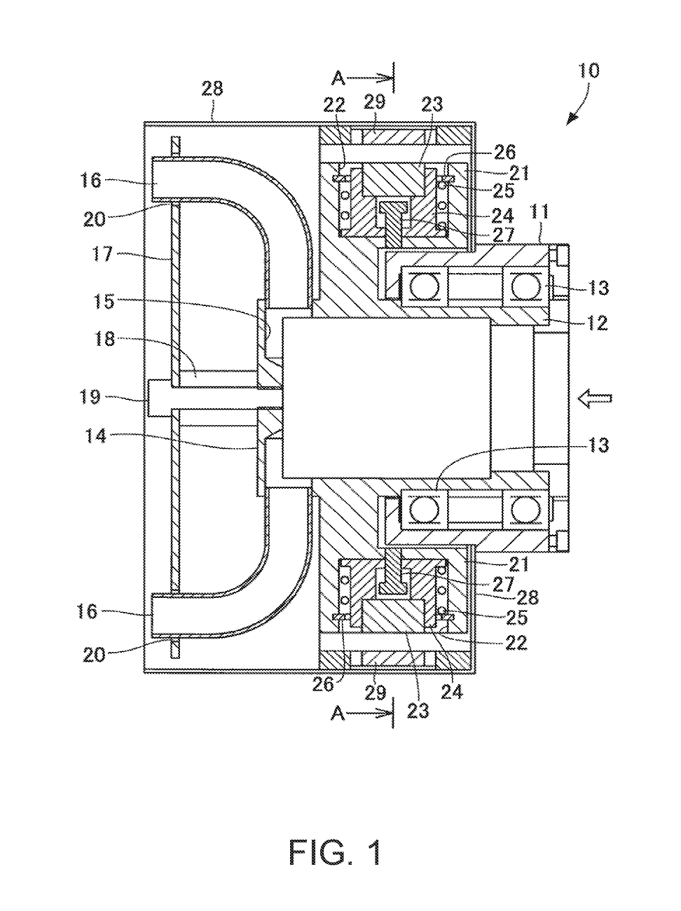

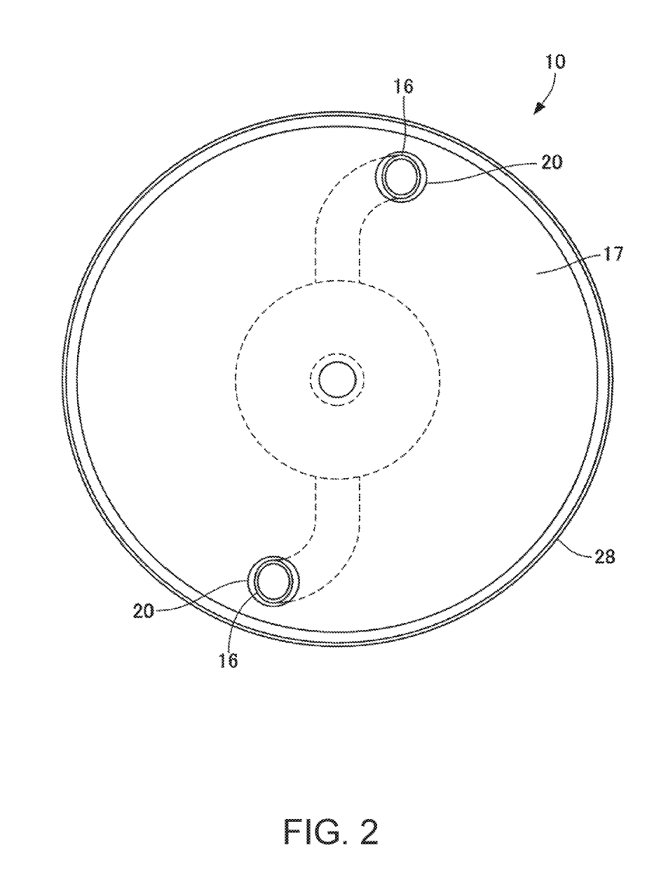

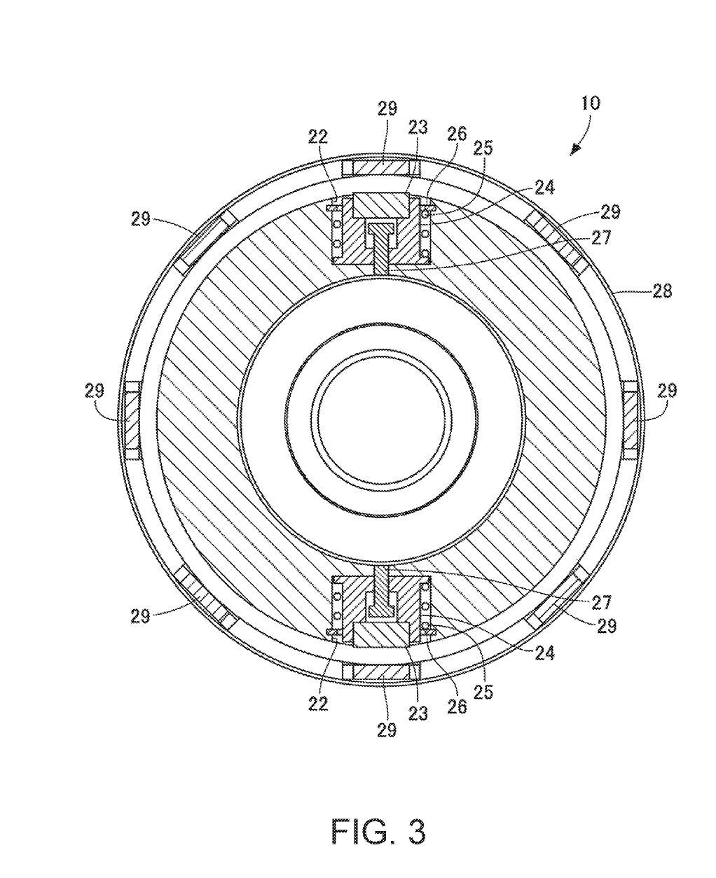

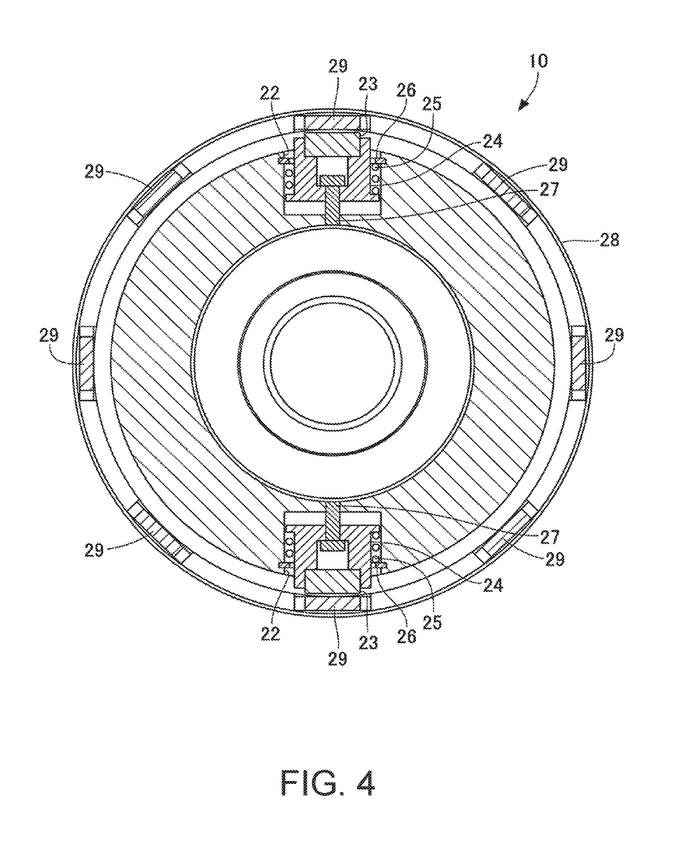

FIG. 1 is a cross-sectional view of a rotational wave nozzle of Embodiment 1. FIG. 2 is a side view of the rotational wave nozzle seen from the side of the spray nozzle. FIG. 3 is a cross-sectional view along the arrow A-A in FIG. 1 and shows the rotational wave nozzle while stopped. FIG. 4 is a cross-sectional view along the arrow A-A in FIG. 1 and shows the rotational wave nozzle while operational.

As shown in FIG. 1, a rotational wave nozzle 10 of Embodiment 1 has a hollow cylindrical fixed housing 11. The fixed housing 11 has a hollow cylindrical rotary cylinder 12 disposed concentrically therein, and the rotary cylinder 12 is supported by two bearings 13 installed inside the fixed housing 11 separated in the axial direction such that the rotary cylinder can rotate freely.

One end of the rotary cylinder 12 is open, and the other end is closed by a closing member 14 formed integrally with the rotary cylinder. Pipe joint parts 15 are formed on the rotary cylinder 12 at the side closed by the closing member 14. The pipe joint parts 15 are formed so as to penetrate through the radial direction and communicate with inside at positions in an axial symmetrical manner about the rotary cylinder 12 (the upper and lower positions in FIG. 1). One ends of spray nozzles 16 are connected to the pipe joint parts 15.

A disc 17 is disposed on the outside of the closing member 14. The disc 17 is fixed by a fastening member 19 to the closing member 14 via a spacer 18. Furthermore, as shown in FIG. 2, the disc 17 has through-holes 20 formed at positions offset in the clockwise direction relative to a center line in the vertical direction. The other end of the spray nozzle 16 is placed so as to go through the through-hole 20. In other words, the spray nozzle 16 extends radially outward from the pipe joint part 15 of the rotary cylinder 12 and bends in the axial direction of the rotary cylinder 12 midway; however, when the spray nozzle is to be connected to the pipe joint part 15, the distal end of the nozzle twists in the direction toward the through-hole 20 and is connected to the pipe joint part 15 in this state. Due to this, the spray nozzles 16 are installed on the rotary cylinder 12 in a state in which the distal end of the nozzle is inclined at a prescribed angle relative to the surface of the disc 17.

In this embodiment, the example includes two of the spray nozzles 16, but the number of spray nozzles 16 may be set as desired. It is also possible to have only one spray nozzle 16, but it is preferable that at least two be provided, because the spray nozzles 16 can make the weight balance during rotational operation uniform by being arranged at equal intervals in the circumferential direction.

Moreover, the ejection direction of the spray nozzle 16 is set to face the direction of a line that is tangent to an imaginary circle passing through the center of the through-hole 20, but the ejection direction is not limited to this. For example, the ejection direction of the spray nozzle 16 can be inclined toward the outer peripheral side or inner peripheral side of the imaginary circle passing through the center of the through-hole 20 relative to the direction of the line that is tangent to the imaginary circle. The inclination of the ejection direction relative to the direction of the tangent line is preferably less than ±20 degrees relative to the tangent line.

The rotary cylinder 12 also has an annular member 21, which functions as a fly wheel, integrally formed on the outer periphery of the rotary cylinder 12. The annular member 21 has a recess 22 formed in a symmetrical position in the outer peripheral surface of the annular member. The recess 22 in the annular member accommodates a mobile attraction member 23, a holder 24 for holding the mobile attraction member 23, and a biasing member 25 for urging the holder 24 inward in the radial direction of the annular member 21. The holder 24 has a flange on the side of the rotation center of the annular member 21, and a retaining ring 26 such as a C-clip, for example, is fitted into a fitting groove formed in the inner wall of the recess 22. The biasing member 25, such as a compression spring, is disposed between the flange of the holder 24 and the retaining ring 26. The radially outward movement amount of the holder 24 is restricted by a movement amount restricting member 27 which has one end fixed to the annular member 21 and the other extending through the holder 24 and having a locking head part on the distal end thereof.

The rotational wave nozzle 10 has a protective cover 28 fixed to the fixed housing 11 so as to cover the rotating annular member 21, spray nozzles 16, and disc 17. In the protective cover 28, a plurality (8 in the example shown in FIG. 3) of fixed attraction members 29 are arranged at equal distances in the circumferential direction on the inner wall of the protective cover facing the mobile attraction members 23.

The mobile attraction members 23 and fixed attraction members 29 constitute a rotation suppressor, whereby the mobile attraction members 23 approach the fixed attraction members 29 due to the centrifugal force caused by rotation of the rotary cylinder 12, and then braking is applied to the rotation by an increase in the attraction acting on both members. The movement of the mobile attraction members 23 due to the centrifugal force is restricted by the movement amount restricting member 27; thus, even if the rotary cylinder 12 were to rotate at an abnormally high speed and cause the mobile attraction members 23 to move radially outward, the mobile attraction members 23 would not contact the fixed attraction members 29.

The mobile attraction members 23 and fixed attraction members 29 can both be magnets, for example. In this case, the mobile attraction members 23 and fixed attraction members 29 may be arranged such that the opposing surfaces thereof are mutually differing magnetic poles. The mobile attraction members 23 and fixed attraction members 29 can constitute a rotation suppressor of the same functionality even if one is a magnet and the other is a ferromagnetic member such as iron.

The rotational wave nozzle 10 of the aforementioned configuration has the fixed housing 11 and rotary cylinder 12 connected to an air compressor via a rotary joint (not shown). When compressed air is not being supplied from the air compressor, the mobile attraction member 23 is in a mutual attraction state with one of the fixed attraction members 29, and the rotary cylinder 12 is stopped from rotating. At this time, as shown in FIG. 1 and FIG. 3, the mobile attraction members 23 of the rotation suppressor are urged by the biasing members 25 to the position furthest from the fixed attraction members 29.

The fluid supplied to the rotational wave nozzle 10 need not be only compressed air, and may be another inert gas such as nitrogen. The fluid supplied to the rotational wave nozzle 10 preferably passes through a filter in order to remove particulates contained in the fluid. In the present embodiment, for example, a filter capable of removing particulates of 10 μm or larger is installed at an upstream side of the rotational wave nozzle 10.

When the air compressor starts up and compressed air is supplied to the rotary cylinder 12, the compressed air passes through the hollow section of the rotary cylinder 12 and is ejected to outside via the spray nozzles 16. Due to this, the ejection of the compressed air produces a propulsive force, which rotates the rotary cylinder 12 in the opposite direction of the direction in which the compressed air is ejected (the counter-clockwise direction in FIG. 2).

As the number of rotations of the rotary cylinder 12 increases, the centrifugal force exerted on the mobile attraction members 23 of the rotation suppressor increases, and as shown in FIG. 4, the mobile attraction members 23 move radially outward against the urging force of the biasing members 25 and approach the fixed attraction members 29. The mobile attraction members 23 approaching the fixed attraction members 29 increase the mutual attractive force therebetween and cause a braking force to be applied to the rotary cylinder 12. When the braking is applied, the number of rotations of the rotary cylinder 12 decreases, and the mobile attraction members 23 move away from the fixed attraction members 29. When the mobile attraction members 23 move away from the fixed attraction members 29, the braking force of the rotary cylinder 12 decreases, and the number of rotations begins to increase again due to the propulsive force from the compressed air.

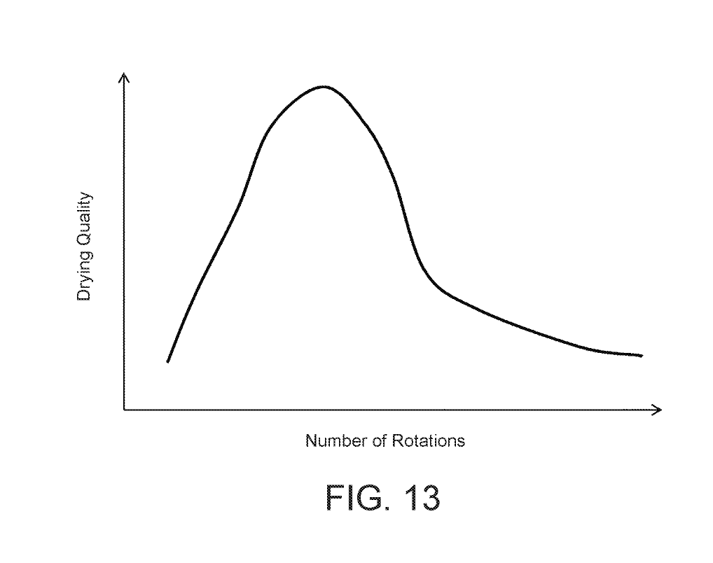

In this manner, while the number of rotations goes up and down, the rotary cylinder 12 is stabilized to a prescribed rotation number range. Even if there are changes in the supply of the compressed air by the air compressor, the rotation suppressor suppresses the rotary cylinder 12 from rotating at or above a prescribed number of rotations, and thus the rotary cylinder 12 will not rotate at an abnormally high speed. Because the rotary cylinder 12 will not rotate at an abnormally high speed, the lifespan of the bearings 13 supporting the rotary cylinder 12 will be longer, and there will also not be noise caused by abnormal rotation. It is preferable that the rotation suppressor function in a range of rotation that is higher than the number of rotations at which drying quality is the greatest (see FIG. 13). Specifically, the spring constant of the biasing member 25 would be selected such that the rotation suppressor begins to function when the rotary cylinder 12 has rotated close to the number of rotations at which drying quality is greatest. This would make it possible to optimize the time it takes for the number of rotations of the rotary cylinder 12 to stabilize.

The two mobile attraction members 23 provided on the periphery of the annular member 21 and the eight fixed attraction members 29 provided inside the protective cover 28 are not limited in number to those above and can be set to any number.

As another embodiment, the rotation suppressor may be such that the mobile attraction members 23 contact the fixed attraction members 29 and the braking is applied to the rotary cylinder 12 from the friction therebetween. This would produce dust due to friction or the like, and thus it is preferable that an exhaust device be connected to the space between the outer peripheral surface of the annular member 21 and the protective cover 28 in order for the friction powder or the like to be exhausted.

Furthermore, when the rotational wave nozzle 10 is used for drying a tray that has been cleaned, two of the rotational wave nozzles 10 may be arranged facing each other, and the tray accommodating semiconductor chips or the like may be vertically reciprocated between the two nozzles.

### Embodiment 2

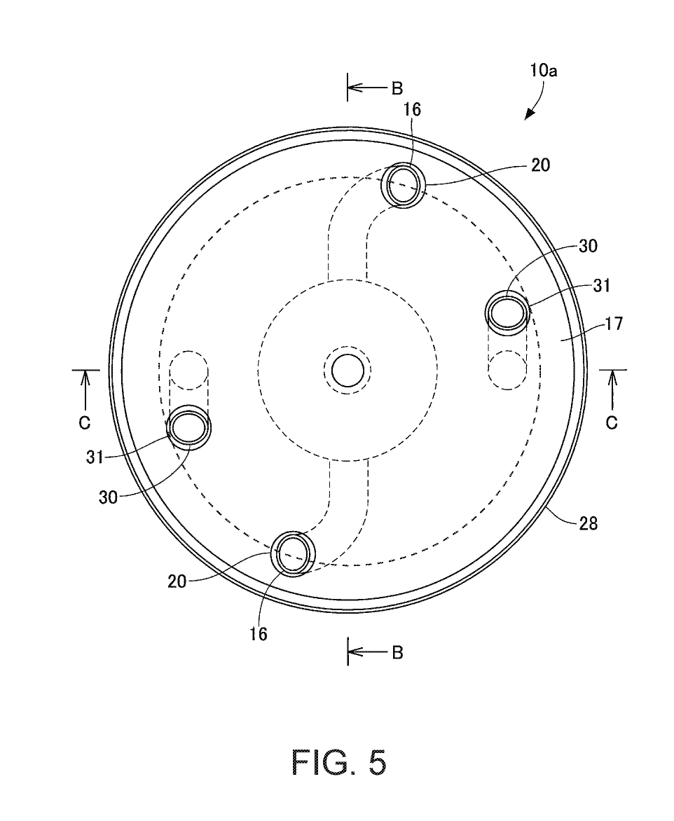

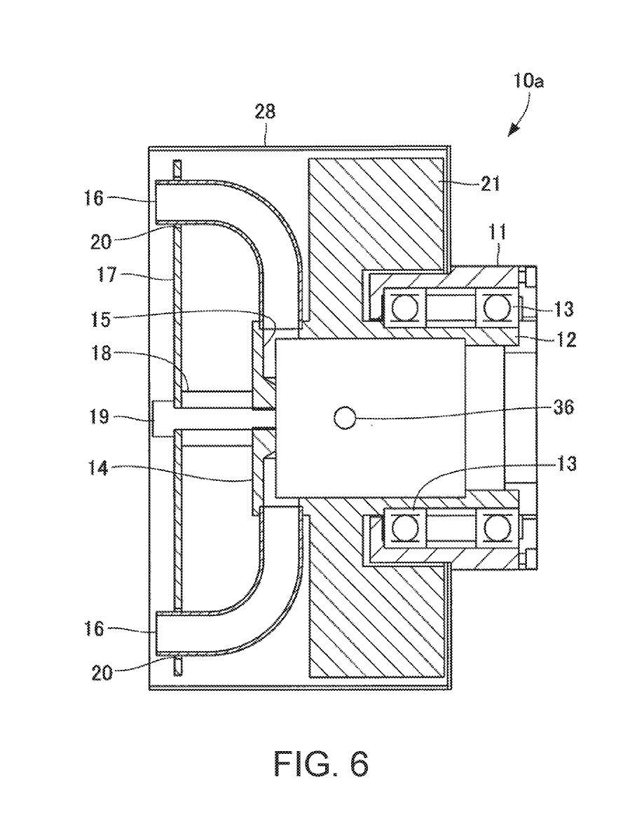

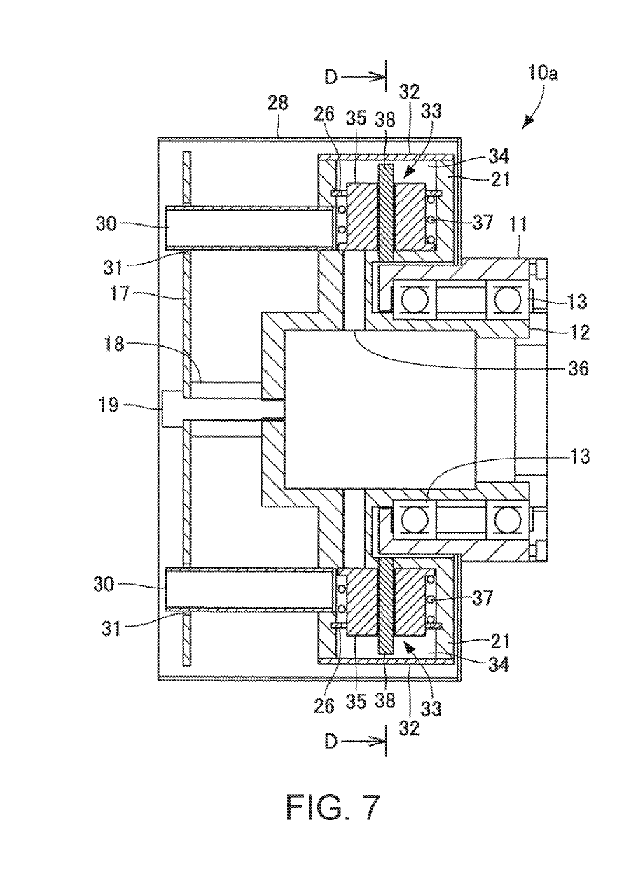

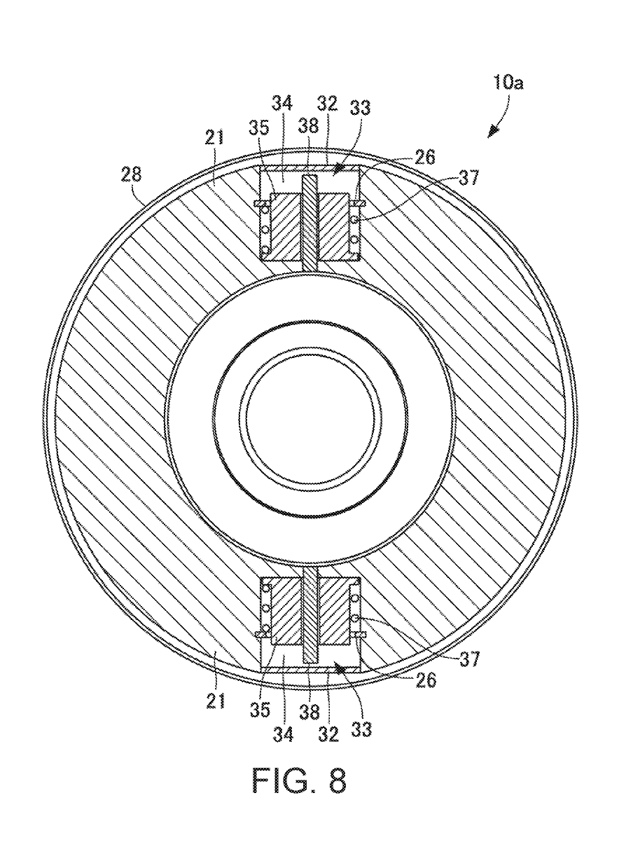

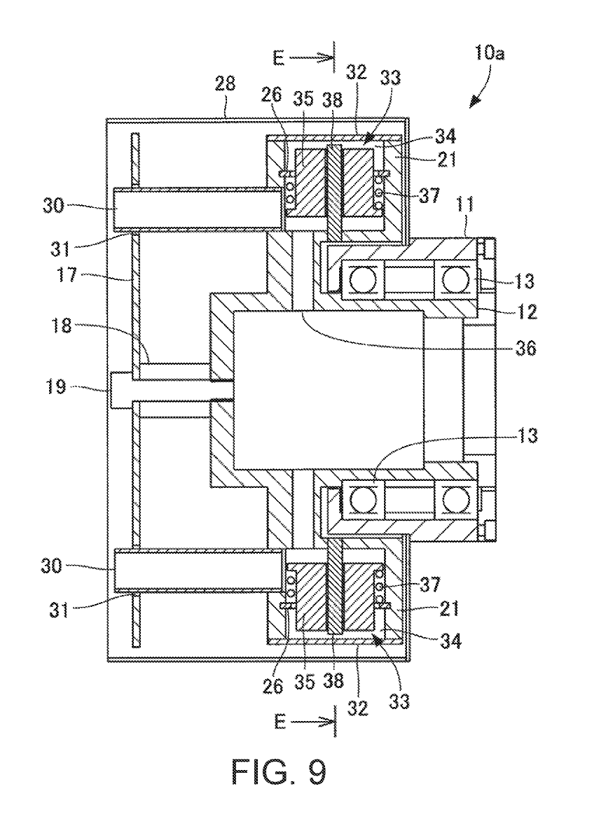

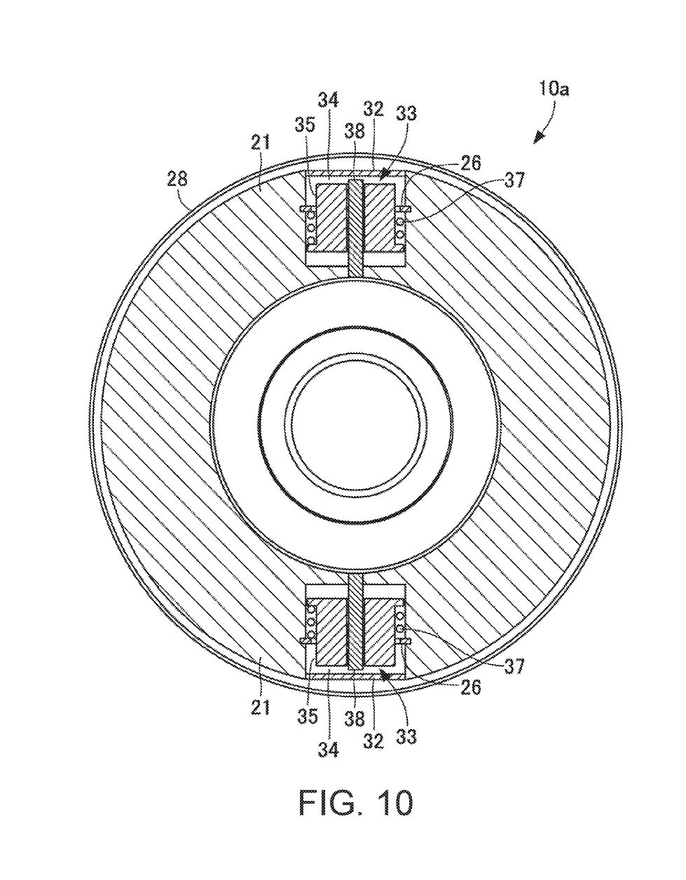

FIG. 5 is a side view of a rotational wave nozzle of Embodiment 2 as seen from the side of the spray nozzle. FIG. 6 is a cross-sectional view along the arrow B-B in FIG. 5 and shows the rotational wave nozzle of Embodiment 2. FIG. 7 is a cross-sectional view along the arrow C-C in FIG. 5 and shows the rotational wave nozzle of Embodiment 2 while stopped. FIG. 8 is a cross-sectional view along the arrow D-D in FIG. 7 and shows the rotational wave nozzle of Embodiment 2 while stopped. FIG. 9 is a cross-sectional view along the arrow C-C in FIG. 5 and shows the rotational wave nozzle of Embodiment 2 while operational. FIG. 10 is a cross-sectional view along the arrow E-E in FIG. 9 and shows the rotational wave nozzle of Embodiment 2 while operational. In FIG. 5 to FIG. 10, the constituent components that are the same as the constituent components shown in FIG. 1 to FIG. 4 are given the same reference characters and detailed explanations thereof will be omitted. Accordingly, in the explanation of Embodiment 2 hereinafter, the configurations and effects of the constituent elements that are the same as the constituent elements of Embodiment 1 can be referenced with the corresponding explanations in Embodiment 1.

As shown in FIG. 5 and FIG. 6, a rotational wave nozzle 10a of Embodiment 2 is the same as the rotational wave nozzle 10 of Embodiment 1 in having the fixed housing 11, rotary cylinder 12, bearings 13, spray nozzles 16, and annular member 21. As shown in FIG. 5 and FIG. 7, in the rotational wave nozzle 10a of Embodiment 2, braking nozzles 30 are provided as a rotation suppressor.

The distal end of the braking nozzle 30 is provided going through a through-hole 31 provided in the disc 17. The braking nozzle 30 is installed on the rotary cylinder 12 in a state in which the distal end of the nozzle is inclined at a prescribed angle relative to the surface of the disc 17, and the orientation of the inclination is the opposite direction to the spray nozzle 16. Due to this, in FIG. 5, the ejection of compressed air from the spray nozzles 16 generates a propulsive force which rotates the rotary cylinder 12 in the counter-clockwise direction, whereas the ejection of compressed air from the braking nozzle 30 generates a propulsive force which rotates the rotary cylinder 12 in the clockwise direction. The propulsive force caused by the braking nozzle 30 weakens the propulsive force caused by the spray nozzles 16, thereby acting to reduce the speed of rotation of the rotary cylinder 12 and to suppress the number of rotations thereof from becoming higher than the prescribed number of rotations.

In order to prevent blocking of the flow of compressed air ejected from the spray nozzle 16, the braking nozzle 30 is not set on the same circle circumference as the imaginary circle passing through the center of the through-hole 20 for the spray nozzle 16. As shown in FIG. 5, in this embodiment, the braking nozzles 30 are disposed on the inner side of the imaginary circle passing through the centers of the through-holes 20 for the spray nozzles 16. In a similar manner to the spray nozzle 16, in the braking nozzle 30, the ejection direction is inclined toward the inner peripheral side or outer peripheral side of the imaginary circle passing through the centers of the through-holes 20 relative to the direction of the tangent to the imaginary circle, so as to prevent interference with the compressed air from the spray nozzles 16 to the greatest extent possible. Furthermore, the inclination angle of the braking nozzles 30 relative to the surface of the disc 17 is smaller than the inclination angle of the spray nozzles 16.

As shown in FIG. 7, the fixed end of the braking nozzle 30 is connected to the annular member 21. The connection part of the annular member 21 connecting with the braking nozzle 30 passes through a centrifugal force operation valve 33 inside the annular member 21 and connects to the hollow section of the rotary cylinder 12.

Each of the centrifugal force operation valve 33 has a valve body 35 accommodated inside each of valve chambers 34 which are installed in recesses at symmetrical positions in the outer peripheral surface of the annular member 21, a valve hole 36 communicating with the valve chamber 34 and hollow part of the rotary cylinder 12, and a biasing member 37 that urges the valve body 35 in a direction for closing the valve hole 36. The valve chamber 34 has the radially outward open end thereof closed by a lid 32. The biasing member 37 has an urging force (spring constant) to a degree where the valve body 35 does not float even when receiving the pressure of the compressed air from the rotary cylinder 12 via the valve hole 36. The valve chamber 34 is connected to the fixed end of the braking nozzle 30, and when the valve body 35 floats due to centrifugal force and the centrifugal force operation valve 33 opens, a portion of the compressed air supplied to the rotary cylinder 12 is distributed to the braking nozzle 30 through the centrifugal force operation valve 33. The valve body 35 is guided reciprocally in the radial direction by a guide pin 38 fixed to the annular member 21, which has one end thereof positioned in the center of the valve chamber 34.

In the rotational wave nozzle 10a having the aforementioned configuration, when the air compressor connected to the rotational wave nozzle has not been started up, the valve body 35 of the centrifugal force operation valve 33 is urged to close by the biasing member 37, as shown in FIG. 7 and FIG. 8.

When the air compressor starts up and compressed air is supplied to the rotary cylinder 12, the compressed air passes through the hollow section of the rotary cylinder 12 and is ejected to outside via the spray nozzles 16. Due to this, the rotary cylinder 12 begins to rotate in the opposite direction of the direction in which the compressed air is ejected by the spray nozzle nozzles 16 (the counter-clockwise direction in FIG. 5). At this time, the centrifugal force operation valves 33 are still closed, and air is not ejected from the braking nozzles 30.

When the number of rotations of the rotary cylinder 12 increases and exceeds the prescribed number of rotations, the centrifugal force acting in the valve opening direction relative to the valve body 35 of the centrifugal force operation valve 33 and the pressure from the compressed air exceed the urging force of the biasing member 37 acting in the valve closing direction relative to the valve body 35. Thus, the valve body 35 of the centrifugal force operation valve 33 is opened by moving in the floating direction, and a portion of the compressed air supplied to the rotary cylinder 12 flows to the braking nozzle 30. At this time, the amount of air ejected from the braking nozzle 30 is small, and therefore the number of rotations of the rotary cylinder 12 will not be reduced.

If the number of rotations of the rotary cylinder 12 continues to increase and the centrifugal force acting on the valve body 35 becomes sufficiently large, then as shown in FIG. 9 and FIG. 10, the centrifugal force operation valve 33 will completely open, and a sufficient amount of air will be ejected from the braking nozzle 30. Due to this, the rotary cylinder 12 will have compressed air ejected in the rotation direction thereof, thereby producing a propulsive force in the opposite direction of the rotation direction and thus lowering the number of rotations. In this manner, as the number of rotations of the rotary cylinder 12 increases, the force for reducing the number of rotations becomes greater, and thus the number of rotations will not become abnormally high.

In the rotational wave nozzle 10a of Embodiment 2, the compressed air supplied to the spray nozzle 16 was divided and used to supply the braking nozzle 30, but the compressed air supplied to the spray nozzle 16 and braking nozzle 30 may be supplied separately. The number of braking nozzles 30 is not restricted to two, and two or more of the braking nozzles, including the centrifugal force operation valve 33, may be arranged at equal intervals on a concentric circle about the rotation center of the rotary cylinder 12.

Furthermore, in the rotational wave nozzle 10a of Embodiment 2, the braking force of the rotary cylinder 12 produced by the rotation suppressor can be adjusted by modifying the spring constant of the biasing member 37, but adjustment is also possible for the braking nozzle 30. In other words, the braking force of the rotary cylinder 12 can be adjusted by moving the ejection position of the braking nozzle 30 to more inside the radial direction than the ejection position of the spray nozzle 16 (the side close to the rotation center) or more outside the radial direction than the ejection position of the spray nozzle (the side far from the rotation center), or by adjusting the inclination angle or orientation relative to the surface of the disc 17.

Moreover, the rotational wave nozzle 10a of Embodiment 2 can be installed such that the distal ends of the spray nozzle 16 and braking nozzle 30 are back-to-back. In this case, it would be possible to suppress almost all interference between the compressed air ejected by the spray nozzle 16 and the compressed air ejected by the braking nozzle 30.

In the embodiments described above, the braking function for the rotary cylinder was a rotation suppressor of a non-contact type, but braking may instead be applied by the direct contact of the inner wall of the protective cover by a mobile member that moves radially outward due to centrifugal force.

In the embodiments described above, a rotational wave nozzle was described in which compressed air was ejected to cause a rotary cylinder to rotate about its own axis, but the present invention can be similarly applied to a rotational wave nozzle in which a different fluid such as gas or liquid is ejected.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. A rotational wave nozzle, comprising:
a fixed housing having a hollow cylindrical shape;
a rotary cylinder supported by two bearings provided separately in an axial direction inside the fixed housing such that the rotary cylinder is freely rotatable about the axial direction, a rear end of the rotary cylinder being configured to receive a compressed gas;
a spray nozzle fixed on a front side of the rotary cylinder, emitting the compressed gas received by the rear end of the rotary cylinder outwardly, an emission direction of the spray nozzle being inclined relative to the axial direction of the rotary cylinder so that the emitted compressed gas causes the rotary cylinder and the spray nozzle fixed thereto to rotate; and
a rotation suppressor fixed on a circumference side of the rotary cylinder, the rotation suppressor having a movable member that moves outwardly in a radial direction in response to a centrifugal force that is generated by the rotation of the rotary cylinder such that the movable member causes the rotation of the rotary cylinder due to the emitted compressed gas to be braked.

2. The rotational wave nozzle according to claim 1, wherein the rotation suppressor comprises:
a mobile attraction member installed in a recess formed in an outer periphery of an annular member fixed to the rotary cylinder, as said movable member, so as to rotate together with the rotary cylinder, said mobile attraction member being movable in a radial direction of the rotary cylinder relative to the annular member, being urged inward in the radial direction of the rotary cylinder by a biasing member, and being moved outwardly in response to the centrifugal force that is generated by the rotation of the rotary cylinder; and
a plurality of fixed attraction members installed on an inner wall of a protective cover that is fixed to the fixed housing so as to surround the annular member, the plurality of fixed attraction members being arranged in a circumferential direction on the inner wall so as to engage with the mobile attraction member in the annular member when the rotary cylinder rotates.

3. The rotational wave nozzle according to claim 2, wherein the mobile attraction member and the fixed attraction members are magnets of opposite polarities.

4. The rotational wave nozzle according to claim 2, wherein one of mobile attraction member and the fixed attraction members is a magnet and the other is a ferromagnetic member.

5. The rotational wave nozzle according to claim 2, wherein the mobile attraction member is held by a holder inside the recess, and the biasing member is disposed between a retaining ring fitted into a fitting groove in an inner wall of the recess and a flange formed on the holder, the mobile attraction member being urged in a direction opposing the centrifugal force.

6. The rotational wave nozzle according to claim 5, wherein radially outward movement amount of the holder is restricted by a movement amount restricting member that has one end fixed to the annular member and another end extending through the holder and having a locking head part on a distal end thereof.

7. The rotational wave nozzle according to claim 1, wherein the spray nozzle is provided in a plurality.

8. The rotational wave nozzle according to claim 2,
wherein the spray nozzle is provided in a plurality, and
wherein the mobile attraction member is provided in a plurality along the outer periphery of the annular member.

9. The rotational wave nozzle according to claim 1, wherein the rotation suppressor comprises:
a braking nozzle that emits a compressed gas outwardly, fixed to an annular member that is fixed to the rotary cylinder so as to rotate together with the rotary cylinder, an emission direction of the braking nozzle being inclined relative to the axial direction of the rotary cylinder in a direction opposite to a direction in which the emission direction of the spray nozzle is inclined so that the compressed gas emitted from the braking nozzle acts as a brake to the rotation of the rotary cylinder; and
a centrifugal force operation valve including:
a valve chamber formed inside the annular member and having a connection part to which one end of the braking nozzle connects and a valve hole communicating with a hollow section of the rotary cylinder;
a valve body movably accommodated in the valve chamber, as said movable member, the valve body being movable in a direction for opening the valve hole in response to the centrifugal force; and
a biasing member that urges the valve body in a direction for closing the valve hole.

10. The rotational wave nozzle according to claim 9, wherein the braking nozzle and the centrifugal force operation valve are each provided in a plurality concentrically at equal intervals about a rotation center of the rotary cylinder.

11. The rotational wave nozzle according to claim 9, wherein the braking nozzle receives a portion of the compressed gas received at the rear end of the rotary cylinder and emits said portion of the compressed gas.
